(19) United States
(12) Patent Application Publication
(10) Pub. No.: US 2010/0165856 A1
(43) Pub. Date: Jul. 1, 2010

(54) CROSS-LAYER OPTIMIZATION IN MULTIMEDIA COMMUNICATIONS

(75) Inventors: Diego Melpignano, Muggio (IT); Nicola Baldo, Rovigo (IT); Federico Maguolo, Mirano (IT); Simone Merlin, Solesino (IT); Andrea Zanella, Vigonza (IT); Michele Zorzi, Mestre (IT); Ida Polato, Mirano-Venezia (IT); Renato Maguolo, Mirano-Venezia (IT); Sandro Maguolo, Mirano-Venezia (IT)

Correspondence Address: GRAYBEAL JACKSON LLP, 400 - 108TH AVENUE NE, SUITE 700, BELLEVUE, WA, 98004, US

(73) Assignee: STMICROELECTRONICS S.R.L., Agrate Brianza (IT)

(21) Appl. No.: 12/347,852

(22) Filed: Dec. 31, 2008

(51) Int. Cl. H04J 1/16; H04W 84/02

(52) U.S. Cl. 370/252; 370/245; 370/338

(57) ABSTRACT

An embodiment of a system for optimizing operation of a mobile station in a wireless communication network such as a WLAN by adapting the physical (PHY), medium access control (MAC), and application settings of a mobile station therein includes a network status estimation module to evaluate the channel conditions of a wireless channel to serve the mobile station in terms of transmission failure probability due to noise and interference, respectively, a transmission characterization module to determine expected network performance as a function of the settings of PHY, MAC and application parameters in the current channel conditions as evaluated by the network status estimation module, a quality evaluation module to determine the expected quality of communication for the mobile station as a function of different channel performance metrics, and a quality maximization module to interact with the characterization and quality evaluation modules to identify and select the settings of PHY, MAC and application parameters for the mobile station that provide an optimum quality for the mobile station.

### CROSS-LAYER OPTIMIZATION IN MULTIMEDIA COMMUNICATIONS RELATED APPLICATION DATA

This application is related to the U.S. patent application Ser. No.: ______ entitled LINK ADAPTATION IN WIRELESS NETWORKS (Attorney Docket No.: 2110-307-03) filed Dec. 31, 2008 and which is incorporated herein in its entirety.

### TECHNICAL FIELD

This disclosure relates to wireless communication systems. This disclosure was devised with attention paid to its possible use in multimedia communications.

### BACKGROUND

Standards such as IEEE 802.11 (ANSI/IEEE Std 802.11, 1999 edition) specify the Medium Access Control (MAC) and PHYsical (PHY) layer characteristics for wireless local area networks (WLANs).

PHY specifications define a plurality of PHY modes for use in the transmission of each frame. Each PHY mode uses a particular modulation and channel coding scheme, and provides different performance levels in terms of transmission duration, overhead, as well as reliability with respect to noise and interference power.

MAC specifications define a Stop&Wait Automatic Retransmission reQuest (ARQ) scheme to enhance wireless link reliability: each MAC frame is transmitted and retransmitted until a positive acknowledgement is returned by the receiver or the maximum number of allowed retransmissions is exceeded. This last parameter is controlled by means of the MAC Retry Limit (RL) setting. High RL values enhance the reliability of end-to-end communication, while lower RL values yield lower end-to-end delay and jitter.

Multimedia communications include several types of applications and services, such as interactive voice and video communications. Generally, such applications use a Real-time Transport Protocol (RTP) in conjunction with different application standards such as H.263 and MPEG-4 (for video), and G.711 and G.729 for voice.

These standards permit use of a variety of configurations for multimedia communications, having different characteristics in terms of packet size and application bit rate. The performance level of each configuration is affected by network performance: e.g. packet delay, jitter, and loss rate may affect the quality of service perceived by the end user. This effect is strong in wireless communication systems such as Wireless Local Area Networks (WLANs); there, the propagation environment changes over time and space due to factors such as mobility and interference, and network performance varies accordingly. Therefore, it is reasonable to say that no PHY, MAC, or application setting exists which can be regarded as optimal under all possible conditions.

### SUMMARY

An embodiment of this disclosure is a cross-layer optimization scheme with the purpose of selecting PHY, MAC, and application settings that provide the best end-user perceived quality, depending on the conditions of the wireless channel.

Another embodiment of this disclosure is an arrangement for adapting the PHY, MAC, and application settings of a mobile station in a wireless local area network (WLAN) according to the estimated channel and interference conditions, to enhance the quality of multimedia communications involving such a mobile station.

One or more embodiments of the disclosure also relate to a corresponding system, a related network, as well as a related computer program product, loadable in the memory of at least one computer and including software code portions for performing the steps of a method when the product is run on a computer. As used herein, reference to such a computer program product is intended to be equivalent to reference to a computer-readable medium containing instructions for controlling a computer system to coordinate the performance of a method. Reference to “at least one computer” is intended to highlight the possibility for an embodiment of the present disclosure to be implemented in a distributed/modular fashion.

An embodiment of the arrangement described herein is a method of adapting the PHY, MAC, and application settings of a mobile terminal in a wireless local area network (WLAN) according to the estimated channel and interference conditions, with the aim of enhancing the quality of multimedia communications that involve the mobile station.

In an embodiment, the mobile station collects MAC-layer statistics regarding the number of successful and unsuccessful transmission/reception events, the number and time duration of channel busy periods, and idle slots.

In an embodiment, these statistics are processed to estimate the collision probability and the signal to noise ratio (SNR) at the receiver side.

In an embodiment, a mathematical model is used to get the expected end-to-end network performance in terms of throughput, delay and packet error rate, for different settings of PHY, MAC and application parameters.

In an embodiment, those particular settings that provide the most satisfactory quality of service for the end user are then selected.

### BRIEF DESCRIPTION OF THE DRAWINGS

One or more embodiments of the disclosure will now be described, by way of example only, with reference to the drawings, wherein:

FIG. 1 is exemplary of a possible scenario of use of an embodiment of the arrangement described herein;

FIGS. 2 and 3 are block diagrams exemplary of certain processing functions as performed in an embodiment of the arrangement described herein; and

FIG. 4 is exemplary of an embodiment of a stack arrangement.

### DETAILED DESCRIPTION

In the following description, numerous specific details are given to provide a thorough understanding of embodiments. The embodiments may be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

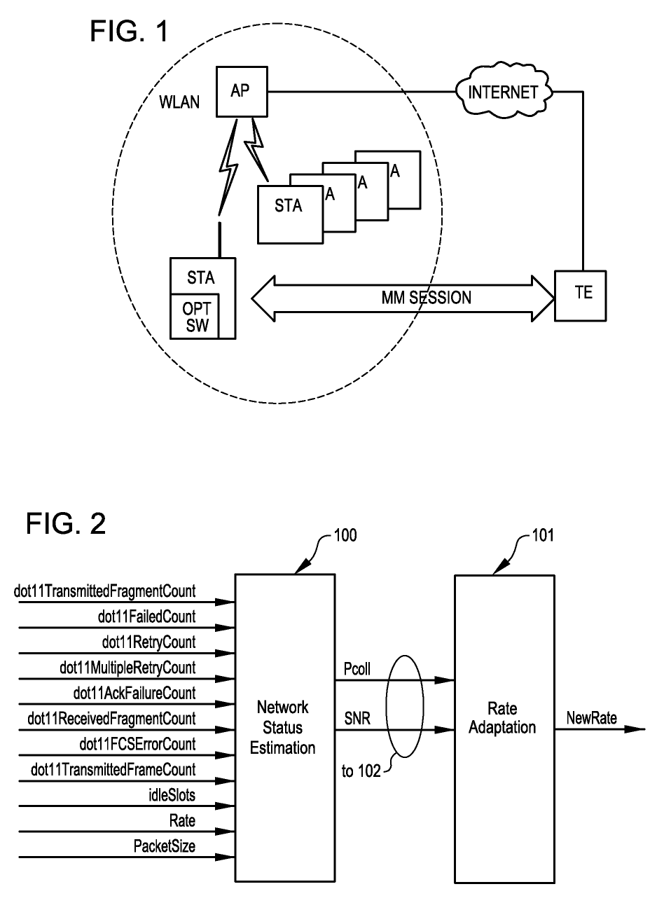

FIG. 1 illustrates a WLAN system architecture related to an embodiment of an arrangement described herein. In particular, this scenario includes one of a plurality of mobile stations (STAs) that may wish to communicate with a remote terminal equipment (TE) in a MultiMedia (MM) session. Communication may be via a Wireless LAN (WLAN) including an access point (AP) and the Internet.

The presence of other active STAs in the WLAN—associated with the same access point (AP)—may potentially compromise the quality of the MM session.

For that reason, the mobile station STA here considered (the same arrangement can be extended to other STAs in the WLAN) includes an optimization function (OPT SW).

In an embodiment, this function includes software running in the mobile station to choose the MAC parameters and the codec settings that optimize the final perceived quality.

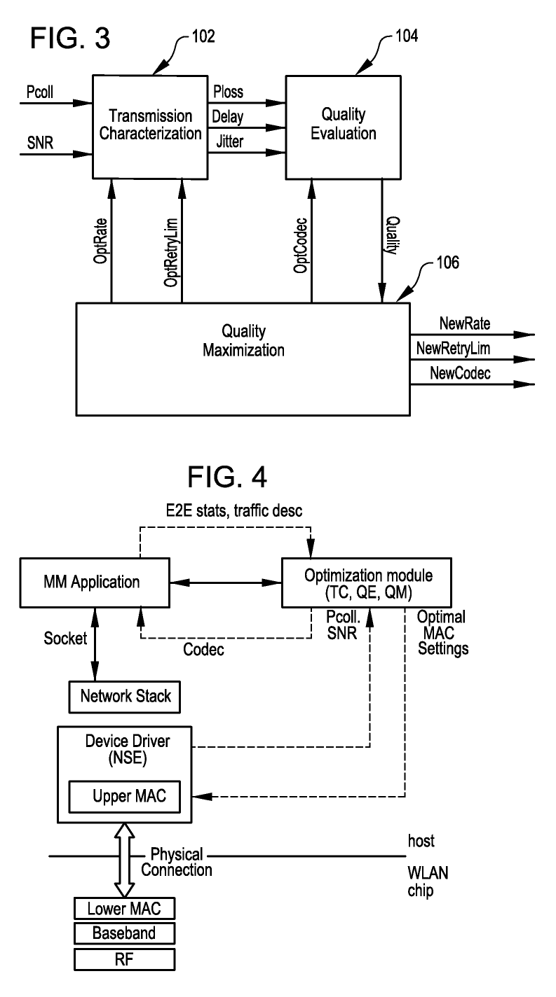

In the exemplary embodiment illustrated herein, the optimization function OPT SW includes four logical blocks 100, 102, 104, 106 (FIGS. 2-3). These may be configured e.g., as hardware blocks or to run as software modules in the mobile terminal STA.

The first module 100 is represented in FIG. 2, while the second, third and fourth modules 102, 104 and 106 are represented in FIG. 3.

The first module 100 is a Network Status Estimation (NSE) module that evaluates the conditions of the wireless channel within the WLAN in terms of transmission failure probability due to noise and interference, respectively. The related values are denoted PER and Pcoll, respectively.

In an embodiment, PER and Pcoll are estimated using MAC statistics as defined by the 802.11 standard (e.g., a list of MAC counters, here), together with information regarding the number of idle timeslots as seen by the device (i.e., the mobile station STA), rate, and packet size.

In an embodiment, the MAC statistics may include a list MAC counters such as:

Dot11TransmittedFragmentCount

Dot11FailedCount

Dot11RetryCount

Dot11MultipleRetryCount

Dot11AckFailureCount

Dot11ReceivedFragmentCount

Dot11FCSErrorCount

Dot11TransmittedFrameCount.

The values thus estimated are then subject to processing in order to return the estimated Pcoll and PER. The estimate of the current Signal-to-Noise Ratio (SNR) experienced by the receiver is, hence, obtained by reverting to a pre-computed PER vs. SNR curve for the PHY mode in use.

Specifically, the estimator 100 is able to distinguish between cases where the link between the STA and the access point AP is noisy (low SNR) and cases where packet losses occur because of network congestion (many other users in the same WLAN or other sources of interference).

A more detailed description of an embodiment of the estimator 100 (and an associated rate adaptation module 101 providing a NewRate value as a function of Pcoll and SNR) can be found in U.S. patent application Ser. No. ______ (Attorney Docket No.: 2110-307-03) filed on Dec. 31, 2008 and commonly assigned. The entire contents of this application are herein incorporated by reference.

The second module 102 in the cross-layer optimization scheme herein is a Transmission Characterization (TC) module that aims at determining the expected network performance (i.e., performance at the link layer) of the considered multimedia communication as a function of the setting of PHY, MAC and application parameters, in the current channel conditions.

Based from Pcoll and SNR as provided by the estimator module 100 (plus other parameters, included OptRate and OptRetxLim, as provided by the module 106), the module 102 computes the expected packet loss rate (Ploss), delay (Delay), and jitter (Jitter) for each possible setting of PHY mode, MAC Retry Limit, and application packet size and bitrate.

The third module 104 in the cross-layer optimization scheme herein is a Quality Evaluation (QE) module, which determines the expected quality of the multimedia communication as a function of different link performance metrics.

In particular, a scalar measurement of the quality (Quality) perceived by the end user is calculated using the packet loss rate, delay, and jitter provided by the second component 102, while taking into account a parameter OptCodec as provided by the module 106.

The fourth module 106 in the cross-layer optimization scheme herein is a Quality Maximization (QM) module, which interacts with the second and third modules 102, 104 in order to identify and select the PHY, MAC, and application setting that provide the highest quality for the end user.

As indicated, the network status estimation module 100 provides two output variables, SNR and Pcoll. The values of these variables are updated at periodic intervals.

The transmission characterization module 102 receives Pcoll and SNR as input variables from the estimation module 100, and OptRate and OptRetryLim as input variables from the optimization module 106.

Furthermore, the module 100 makes use of Lsize and lambda parameters, which correspond to the average source packet size and generation rate and are provided by the application layer or RTP protocol through a suitable cross-layer plane whose definition and realization is not part of this disclosure.

For each combination of the values assumed by the input variables, the characterization module 102 calculates the output variables Ploss, Delay, and Jitter.

Specifically:

Ploss=PF.̂(OptRetryLim);

where:

PF=Pcoll+(1−Pcoll).*PER;

PER=fun_PER80211g(OptRate,SNR,Lsize) is the error probability of a packet of size Lsize when transmitted with a PHY mode that provides PHY rate OptRate, for a signal to noise ratio at the receiver side of SNR.

The value for fun_PER80211g(r,s,l) can be determined with any known method in the literature.

Delay=mc+mst+dbuff;

where
mc is the average algorithmic and packeting delay associated with the voice codec in use and the processing delay introduced by the protocol stack up to the MAC layer, which are known for most of current voice codecs,
dbuff is the average playout buffer delay that is assumed to be negotiated by the units before the beginning of the data flow and, then, passed to the embodiment through the cross-layer control plane already mentioned.
mst is the average one-way network delay of successfully delivered packets, which is given by

mst=mse+ms

where:
mse accounts for the time taken by the packet to reach the final destination, once transmitted over the wireless link, which can be estimated from the measurements provided by the application and/or RTP layer, through the above-mentioned cross-layer plane. An accurate estimate of this parameter is not critical for the correct functioning of this disclosure.
ms is the average time the packet spends at the MAC layer to be successfully delivered to the next-hop MAC entity.

The parameter ms is approximated by the expectation of the system delay s:

ms=E[s]

whereas the jitter parameter expected by the module 102 is given by

jitter=E[(s−ms)̂2]

The system delay s, in turn, is expressed as

s=w+y1

where
y1 is the service time of a successfully delivered packet, i.e., the time that a packet spends at the head of the MAC queue before being successfully delivered, under the condition that it is successfully delivered within OptRetryLimit transmission attempts.

The term w represents the queue delay, i.e., the time that the packet spends in the MAC queue before reaching the head of the queue. The statistics of queuing delay w may be obtained form classical queuing theory, by modelling the system as a D/G/1 queue under the simplifying assumption that the service time of successive packets are mutually independent random variables with common distribution. For instance, the moment generating function Gw(z), that is the z-transform of the probability distribution function of w discretized with a time granularity of 1/(N*lambda), is given by

Gw(z)=A(prod_{—}{r=1}̂{N−1}(z−zr) )(z−1)/(ẑN−Gy(z))

where
Gy(z) is the z-transform of the service delay quantized in multiples of 1/(N*lambda) and

zr, r=1,2, . . . ,N−1

are the unique roots of the complex polynomial ẑN−Gy(z)=0.
Gy(z) can be derived following the footprints of Andrea Zanella, Francesco De Pellegrini, ‘Statistical characterization of the service time in saturated IEEE 802.11 networks’, IEEE communications letters, pp 225-227, March 2005, which is incorporated by reference, i.e., computing the moment generating function of the random variable

y=sum_{—}{i=1}̂rmax ys(i)*xis(i)+yd*xid

where
rmax is a MAX parameter (OptRetryLimit) that gives the maximum number of unsuccessful transmission attempts that a MAC Protocol Data Unit (PDU) can undergo before being dropped by the MAC layer
ys(i) is the service time in case the MPDU is successfully acknowledged at the i-th transmission attempt
xs(i) is an indicator variable that is equal to one if the i-th transmission attempt is successful and zero otherwise
yd is the service time in case the MPDU is dropped because not successfully acknowledged after rmax transmission attempts
xid is an indicator variable that is equal to one if the rmax transmission attempts fail.

The random variables ys(i) can be obtained as

ys(i)=sum_{—}{h=0}̂i B(h)+i Tf+Ts

where
Ts is the channel busy time in case of a successful packet transmission (comprehensive of the on-air packet transmission time, followed by the SIFS, the ACK transmission time and the DIFS)
Tf is the average channel-busy time in case of unsuccessful packet transmissions. Notice that, in case of collision, the channel remains busy for a time equal to the longest duration amongst the colliding packets, plus and EIFS interval; whereas in case of failures due to the radio channel, the busy period is basically equal to Ts. A possible approximation of Tf is
Tf=\max(TB,Ts)Pcoll/Ploss+Ts(1−Pcoll/Ploss), where TB is the average channel occupancy time for a packet transmitted by any other node in the network (comprehensive of SIFS, ACK and DIFS), as measured by the MAC layer.

B(h) is the time spent to perform the h-th backoff stage and can be expressed as follows

B(h)=sum_{—}{r=0}̂{CW(h)−1}xib(r) sum_{—}{j=1}̂r tick(j)

where

CW(h)=CW0 2̂min(h,m0)

is the size of the backoff window at the h-th transmission attempts of the same MPDU, CW0 is the minimum backoff window size and m0 determines the maximum backoff window size (Cw0 2̂m0). CW0 and m0 are MAC parameters whose values are defined by the standard.
xib(r) is an indicator random variable that equals one if the random backoff value generated at the beginning of the h-th backoff stage (i.e., at the h-th transmission attempt) is equal to r, and zero otherwise. Assuming that the backoff value is uniformly picked in the backoff window {0,1, . . . ,CW(h)−1}, then for any r in {0,1, . . . ,CW(h)−1} we have

P[xib(r)=1]=1/CW(h)

tick(j) is the time duration of the j-th tick period of a backoff stage, i.e. the time taken to decrement the backoff counter from j to j−1. Note that tick(0)=0 by assumption. In steady state conditions, the terms tick(j), with j>0, can be considered as independent identically distributed random variables whose statistics might be directly estimated by the MAC layer (though this feature is usually not supported by commercial cards). Otherwise, the tick period can be approximated as

tick=Tslot+TB*xiB

where Tslot is the standard slot duration, TB is the average duration of the busy periods, as measured by the MAC layer, and xiB is the fraction of busy ticks over the total number of ticks observed by the MAC layer in a given observation period. In this disclosure, we assume that the expectation of xiB is equal to Pcoll.

The service time y1 of successfully delivered packets can expressed as

Y1=sum_{—}{i=1}̂rmax ys(i)*xis1(i

where xis1 is equal to one if the i-th transmission attempt is successful and zero otherwise, given that the packet is successfully acknowledged within rmax transmission attempts.
The embodiment of the method described above is just one of the possible ways to obtain ms and jitter. That is, any other embodiments for estimating ms and jitter may be used instead.

The evaluation module 104 receives as an input from the characterization module 102 the Ploss, Delay and Jitter variables, and from the module 106 the OptCodec variable, which indicates a type of voice codec.

The output from the module 104 is a quality variable, which represents e.g., the E-model rating calculated as described in ITU-T Recommendation G.107: The E-Model, a computational model for use in transmission planning, December 1998, which is incorporated by reference.

The quality maximization module 106 provides a first set of output variables, OptRate, OptRetryLim and OptCodec, which represent possible values for the PHY rate, the MAC Retransmission Limit and the voice codec, for use by the modules 102 and 104.

The quality maximization module 106 also generates a second set of output variables, NewRate, NewRetryLim and NewCodec, which represent the optimal settings for the PHY rate, the MAC Retransmission Limit, and the voice codec at the end of the optimization process carried out by the quality maximization module 106.

The optimization process is carried out by the quality maximization module 106 in the following way.

The quality maximization module 106 applies—e.g., by operating off-line—a plurality of (for example, all) possible combinations of values for the output variables OptRate, OptRetryLim, and OptCodec.

Generally, for each combination, a different value of the Quality variable is obtained by the evaluation module 104. The quality maximization module 106 sets the NewRate, NewRetryLim and NewCodec variables to the values of OptRate, OptRetryLim and OptCodec which have been observed to provide the maximum quality. These values are put in a look up table, so that at run time the optimal values can be selected and applied based on the input parameters.

In an embodiment, the optimization process can be performed offline for all admissible values of the variables Pcoll and SNR. In that way, for each value assumed by Pcoll and SNR, an optimal combination of values for NewRate, NewRetryLim and NewCodec can be determined.

This information is then stored in a non-volatile memory, and the optimal set of values for NewRate, NewRetryLim and NewCodec is determined at runtime for each value of Pcoll and SNR which is provided by the NSE.

Transmission quality may not depend exclusively on the conditions of the wireless LAN but also on the other links that form the path from source to destination of the multimedia transmission.

Therefore, the evaluation module 104 may be configured in order to take other inputs into account, for example the RTCP end-to-end statistics messages that are part of the Real Time Protocol standard.

An embodiment of the arrangement described herein is applicable, for example, to a Voice over IP over WLAN mobile terminal based on ST Nomadik™ System-on-Chip as the host.

FIG. 4 depicts a diagram of an embodiment of a SW stack architecture for use in the arrangement described herein.

The modules that concur in optimizing the MM transmission have been split in such a way that the network status estimator module (100 in FIG. 1) is added to the WLAN device driver in the host operating system kernel space. The other modules (transmission characterization 102, quality evaluation 104, quality maximization 106) may be implemented in the OS user space and may be either part of the multimedia application or reside in a separate daemon, which communicates with the application through an Inter Process Communication mechanism.

The optimization module OPT SW in the mobile station STA interacts with both the device driver and the MM application. It receives indications on the collision probability and the estimated SNR by the device driver. Communication between the optimization module OPT SW and the device driver may be OS specific. In Linux, for example, the statistics could be exported in the /proc filesystem, while commands to configure MAX parameters may be sent through ioctl( ) calls, once the driver is loaded.

Traffic description and (optionally) end-to-end statistics may be sent to the optimization module from the application. With this information available, the optimization module may apply an embodiment of the procedure described herein to select the optimal MAC parameters (that are sent to the device driver) and the optimal application settings (that are sent to the application). A suitable protocol may be defined between the application and the optimization module to exchange this information.

Changing the application will not affect the overall architecture, but only the values for the parameters that have to be passed from the application to the optimization module. The choice of the optimal codec to be used (and its performance characterization in the evaluation module 102) may depend on the application type and its constraints. Changes in the codec type and/or other parameters may also involve a successful negotiation between the terminal where the change is suggested and the other peer in the multimedia session (i.e., STA and TE in FIG. 1).

An embodiment of the arrangement described herein is applicable e.g., to Voice over IP over WLAN portable terminals, including mobile phones, and PDA's and Internet Tablets, where voice quality maximization is achieved. Other applications that may benefit from adopting the arrangement described herein include HDTV transmission and multimedia streaming in a home WLAN network, in the presence of congestion, interference, and/or noise.

Without prejudice to the underlying principles of the disclosure, the details and the embodiments may vary, even appreciably, with respect to what has been described by way of example only, without departing from the scope of the disclosure.

1. A method of cross-layer optimizing operation of a mobile station in a wireless communication network by adapting the physical, medium access control and application settings of said mobile station, the method including:
evaluating the channel conditions of a wireless channel to serve said mobile station in said network in terms of transmission failure probability due to noise and interference, respectively;
determining expected network performance as a function of the settings of PHY, MAC and application parameters a mobile station in the current channel conditions as evaluated by said first module;
determining the expected quality of communication for said mobile station as a function of different channel performance metrics; and
identifying and selecting, as a function of said determining, the settings of PHY, MAC and application parameters for said mobile station that provide an optimum quality for said mobile station.

2. The method of claim 1, including evaluating said channel conditions in terms of transmission failure probability due to noise and interference, respectively.

3. The method of claim 2, including updating at periodic intervals said transmission failure probability due to noise and interference.

4. The method of claim 1, including evaluating said channel conditions using parameters selected out of MAC statistics, the number of idle timeslots as seen by the mobile station, transmission rate, and packet size.

5. The method of claim 4, wherein said MAC statistics include a list MAC counters selected out of:
Dot11TransmittedFragmentCount
Dot11FailedCount
Dot11RetryCount
Dot11MultipleRetryCount
Dot11AckFailureCount
Dot11ReceivedFragmentCount
Dot11FCSErrorCount
Dot11TransmittedFrameCount.

6. The method of claim 1, including providing an estimate of the current signal-to-noise ratio experienced by said mobile station by reverting a pre-computed curve for transmission failure probability due to noise versus SNR curve for the PHY setting in use.

7. The method of claim 1, including evaluating the channel conditions of said wireless channel by distinguishing between cases where said wireless channel is noisy and cases where packet losses occur because of network congestion.

8. The method of claim 1, including determining said expected network performance in terms of expected packet loss rate, delay and jitter for each possible setting of PHY mode, MAC Retry Limit, and application packet size, and bit rate.

9. The method of claim 1, including determining said expected quality of communication for said mobile station as a function of said expected network performance in terms of expected packet loss rate, delay and jitter as provided by said second module.

10. The method of claim 9, including determining said expected quality of communication for said mobile station by taking into account information on a voice codec type adopted by said mobile station.

11. The method of claim 1, including determining said expected quality of communication as a quality variable representing the E-model rating of communication for said mobile station.

12. The method of claim 1, including providing at least one output variable selected out of output variables representative of values for the PHY rate, the MAC Retransmission Limit and a voice codec type adopted, for use in determining at least one of said expected network and said expected quality of communication.

13. The method of claim 1, including providing output variables representative of the optimal settings for the PHY rate, the MAC Retransmission Limit and the voice codec for use by said mobile station.

14. The method of claim 13, including:
providing plural combinations of values for settings for the PHY rate, the MAC Retransmission Limit and the voice codec,
determining the expected quality of communication for said mobile station for each of said plural combinations, and
providing as said output optimal settings for the PHY rate, the MAC Retransmission Limit and the voice codec for use by said mobile station the values PHY rate, the MAC Retransmission Limit and the voice codec which provide the best value for said expected quality of communication.

15. The method of claim 13, including storing said optimal settings for runtime retrieval by said mobile station as a function of said channel conditions as evaluated.

16. A system for optimizing operation of a mobile station in a wireless communication network by adapting the physical, medium access control (MAC) and application settings of said mobile station, the system including:
a first module to evaluate the channel conditions of a wireless channel to serve said mobile station in said network in terms of transmission failure probability due to noise and interference, respectively;
a second module to determine expected network performance as a function of the settings of PHY, MAC and application parameters a mobile station in the current channel conditions as evaluated by said first module;
a third module to determine the expected quality of communication for said mobile station as a function of different channel performance metrics; and
a fourth module to interact with said second and third modules to identify and select the settings of PHY, MAC and application parameters for said mobile station that provide an optimum quality for said mobile station.

17. The system of claim 16, including said first module to evaluate said channel conditions in terms of transmission failure probability due to noise and interference, respectively.

18. The system of claim 17, including said first module to update at periodic intervals said transmission failure probability due to noise and interference.

19. The system of claim 16, including said first module to evaluate said channel conditions using parameters selected out of MAC statistics, the number of idle timeslots as seen by the mobile station, transmission rate, and packet size.

20. The system of claim 19, wherein said MAC statistics include MAC counters selected out of:
Dot11TransmittedFragmentCount
Dot11FailedCount
Dot11RetryCount
Dot11MultipleRetryCount
Dot11AckFailureCount
Dot11ReceivedFragmentCount
Dot11FCSErrorCount
Dot11TransmittedFrameCount.

21. The system of claim 16, including said first module to provide an estimate of the current signal-to-noise ratio experienced by said mobile station by reverting a pre-computed curve for transmission failure probability due to noise versus signal-to-noise ratio curve for the PHY setting in use.

22. The system of claim 16, including said first module to distinguish between cases where said wireless channel to serve said mobile station is noisy and cases where packet losses occur because of network congestion.

23. The system of claim 16, including said second module to determine said expected network performance in terms of expected packet loss rate, delay and jitter for each possible setting of PHY mode, MAC Retry Limit, and application packet size and bit rate.

24. The system of claim 16, including said third module to determine said expected quality of communication for said mobile station as a function of said expected network performance in terms of expected packet loss rate, delay and jitter as provided by said second module.

25. The system of claim 24, including said third module to determine said expected quality of communication for said mobile station by taking into account information on a voice codec type adopted as provided by said fourth module.

26. The system of claim 16, including said third module to determine said expected quality of communication as a quality variable representing the E-model rating of communication for said mobile station.

27. The system of claim 16, including said fourth module providing at least one output variable selected out of output variables representative of values for the PHY rate, the MAC Retransmission Limit and a voice codec type adopted, for use by at least one of said second and third modules.

28. The system of claim 16, including said fourth module to provide output variables representative of the optimal settings for the PHY rate, the MAC Retransmission Limit and the voice codec for use by said mobile station.

29. The system of claim 28, including:
said fourth module to provide to said second and third modules plural combinations of values for settings for the PHY rate, the MAC Retransmission Limit and the voice codec,
said third module to determine the expected quality of communication for said mobile station for each of said plural combinations, and
said fourth module to provide as said output optimal settings for the PHY rate, the MAC Retransmission Limit and the voice codec for use by said mobile station the values PHY rate, the MAC Retransmission Limit and the voice codec which provide the best value for said expected quality of communication.

30. The system of claim 28, including said fourth module having associated a memory to store said optimal settings for runtime retrieval by said mobile station as a function of said channel conditions as evaluated by said first module.

31. The system of claim 30, wherein said first module and said associated memory comprise on-board processing capability equipping said mobile station.

32. A wireless communication network including at least one mobile station wherein the physical, medium access control and application settings of said mobile station are adjustable, the network equipped with:
a first module to evaluate the channel conditions of a wireless channel to serve said mobile station in said network in terms of transmission failure probability due to noise and interference, respectively;
a second module to determine expected network performance as a function of the settings of PHY, MAC and application parameters a mobile station in the current channel conditions as evaluated by said first module;
a third module to determine the expected quality of communication for said mobile station as a function of different channel performance metrics; and
a fourth module to interact with said second and third modules to identify and select the settings of PHY, MAC and application parameters for said mobile station that provide an optimum quality for said mobile station.

33. The network of claim 32, wherein said network is a WLAN.

34. A computer program product, loadable in the memory of at least one computer and including software code portions for performing a method of cross-layer optimizing operation of a mobile station in a wireless communication network by adapting the physical, medium access control (MAC) and application settings of said mobile station, the method including:
evaluating the channel conditions of a wireless channel to serve said mobile station in said network in terms of transmission failure probability due to noise and interference, respectively;
determining expected network performance as a function of the settings of PHY, MAC and application parameters a mobile station in the current channel conditions as evaluated by said first module;
determining the expected quality of communication for said mobile station as a function of different channel performance metrics; and
identifying and selecting, as a function of said determining, the settings of PHY, MAC and application parameters for said mobile station that provide an optimum quality for said mobile station.

35. A method of adapting the physical, medium access control (MAC) and application settings of a mobile terminal in a wireless network, said mobile terminal having a receiver side, the method including:
said mobile terminal collecting MAC-layer statistics regarding the number of successful and unsuccessful transmission/reception events, channel busy periods and idle slots;
processing said statistics to estimate the collision probability and the signal-to-noise ratio at the receiver side of said mobile terminal,
evaluating from said estimated collision probability and signal-to-noise ratio expected end-to-end network performance in terms of throughput, delay and packet error rate, for different settings of PHY, MAC and application parameters, and
selecting for use by said mobile terminal those PHY, MAC and application settings that provide optimum quality of service for said mobile terminal.

36. A method, comprising:
determining a collision-failure probability that an exchange of first data over a wireless channel involving a first unit during a first period will fail due to an exchange of second data over the channel involving a second unit during the first period;
determining a channel-failure probability that the exchange of the first data over the channel will fail due to a characteristic of the channel; and
selecting in response to the collision- and channel-failure probabilities a first data-exchange parameter that provides at a receiver of the first data a quality of service that exceeds a level.

37. The method of claim 36 wherein determining the collision-failure probability comprises determining the probability that a transmission of the first data over the wireless channel by the first unit during the first period will not be received by a receiver due to transmission of the second data over the channel during the first period.

38. The method of claim 36 wherein determining the collision-failure probability comprises determining the probability that the first unit will not receive the first data during the first period due to transmission of the second data over the channel during the first period.

39. The method of claim 36 wherein determining the collision-failure probability comprises determining the collision-failure probability based on a number of times during a second period that multiple sources transmit data over the channel during a same portion of the second period.

40. The method of claim 39 wherein the second period occurs before the first period.

41. The method of claim 36 wherein determining the channel-failure probability comprises determining the channel-failure probability based on a number of times during a second period that transmission of data fails while only one source is transmitting data over the channel.

42. The method of claim 36, further comprising:
determining a signal-to-noise ratio of the channel from the channel-failure probability; and
selecting the data-exchange parameter in response to the collision-failure probability and the signal-to-noise ratio.

43. The method of claim 36 wherein selecting the data-exchange parameter comprises selecting the data-exchange parameter from a look-up table.

44. The method of claim 36 wherein selecting the data-exchange parameter comprises calculating the data-exchange parameter.

45. The method of claim 36 wherein the data-exchange parameter comprises a rate at which the first data is transmitted.

46. The method of claim 36 wherein the data-exchange parameter comprises a number of times that transmission of the first data is attempted before transmission of the first data is aborted.

47. The method of claim 36 wherein the data-exchange parameter comprises an identity of an encoder/decoder for encoding/decoding the first data.

48. The method of claim 36 wherein the characteristic of the channel comprises noise.

49. The method of claim 36, further comprising selecting in response to the collision- and channel-failure probabilities a second data-exchange parameter that together with the first data-exchange parameter provides at the receiver of the first data a quality of service that exceeds a level.

50. A communication unit, comprising:
a first module operable to determine a value of a collision-failure probability that a transmission of first data over a wireless channel during a first period will fail due to a transmission of second data over the channel from another source during the first period;
a second module operable to determine a value of a channel-failure probability that the transmission of the first data over the channel will fail due to a characteristic of the channel;
a third module operable to select in response to the collision- and channel-failure probabilities a value of a first data-transmission parameter that is estimated to provide at a receiver of the first data a quality of service; and
a transmitter operable to transmit the first data according to the selected value of the first data-transmission parameter.

51. The communication unit of claim 50 wherein at least one of the first, second, and third modules comprises a respective software component.

52. The communication unit of claim 50 wherein at least one of the first, second, and third modules comprises a respective hardware component.

53. The communication unit of claim 50 wherein the first module is operable to determine the collision-failure probability that a transmission of the first data over the channel to a receiver during the first period will fail due to a transmission of the second data over the channel from another source to the receiver during the first period.

54. The communication unit of claim 50, further comprising a receiver.

55. The communication unit of claim 50, further comprising:
a memory operable to store values of the data-exchange parameter corresponding to respective pairs of values of the collision- and channel-failure probabilities; and
wherein the third module is operable to select the value of the data-exchange parameter from a storage location of the memory that corresponds to the determined values of the collision- and channel-failure probabilities.

56. The communication unit of claim 50 wherein the third module is operable:
to estimate a quality of service at the receiver based on the collision- and channel-failure probabilities and a first value of the data-exchange parameter;
to change the data-exchange parameter to a second value;
to estimate the quality of service at the receiver based on the collision- and channel-failure probabilities and the second value of the data-exchange parameter;
to continue to change the value of the data-exchange parameter and to estimate the quality of service for a predetermined number of values of the data-exchange parameter; and
to select the value of the data-exchange parameter that provides the highest quality of service.

57. The communication module of claim 50 wherein:
the third module is operable to select in response to the collision- and channel-failure probabilities a value of a second data-transmission parameter, the values of the first and second data-transmission parameters being estimated to provide at the receiver of the first data the quality of service; and
a transmitter is operable to transmit the first data according to the selected values of the first and second data-transmission parameters.

58. A communication unit, comprising: a receiver;
a first module operable to determine a value of a collision-failure probability that a reception by the receiver of first data transmitted by a first transmitter over a wireless channel during a first period will not occur due to a transmission of second data over the channel during the first period;
a second module operable to determine a value of a channel-failure probability that the reception by the receiver of the first data will not occur due to a characteristic of the channel;
a third module operable to select in response to the collision- and channel-failure probabilities a value of a first data-transmission parameter that is estimated to provide a quality of service for data received by the receiver; and
a second transmitter operable to transmit the selected value of the first data-transmission parameter to the first transmitter.

59. The communication unit of claim 58, further comprising:
a memory operable to store values of the data-exchange parameter corresponding to respective pairs of values of the collision- and channel-failure probabilities; and
wherein the third module is operable to select the value of the data-exchange parameter from a storage location of the memory that corresponds to the determined values of the collision- and channel-failure probabilities.

60. The communication unit of claim 58 wherein the third module is operable:
to estimate a quality of service for data received by the receiver based on the collision- and channel-failure probabilities and a first value of the data-exchange parameter;
to change the data-exchange parameter to a second value;
to estimate the quality of service based on the collision- and channel-failure probabilities and the second value of the data-exchange parameter;
to continue to change the value of the data-exchange parameter and to estimate the quality of service for a predetermined number of values of the data-exchange parameter; and
to select the value of the data-exchange parameter that provides the highest estimated quality of service.

61. The communication module of claim 58 wherein:
the third module is operable to select in response to the collision- and channel-failure probabilities a value of a second data-transmission parameter that together with the value of the first data-transmission parameter is estimated to provide the quality of service for the data received by the receiver; and
a second transmitter operable to transmit the selected value of the second data-transmission parameter to the first transmitter.

62. A method, comprising:
estimating a received-data quality of service for a first value of a collision-failure probability, a first value of a channel-failure probability, and a value of a first data-exchange parameter;
changing the value of the data-exchange parameter;
estimating the quality of service for the first value of the collision-failure probability, the first value of the channel-failure probability, and the changed value of the data-exchange parameter; and
continuing to change the value of the data-exchange parameter and to estimate the quality of service over a range of values of the data-exchange parameter; and
storing the value of the data-exchange parameter that yields the best quality of service for the first values of the collision- and channel-failure probabilities.

63. The method of claim 62, further comprising:
estimating a received-data quality of service for a second value of the collision-failure probability, a second value of the channel-failure probability, and a value of a data-exchange parameter;
changing the value of the data-exchange parameter;
estimating the quality of service for the second value of the collision-failure probability, the second value of the channel-failure probability, and the changed value of the data-exchange parameter; and
continuing to change the value of the data-exchange parameter and to estimate the quality of service over a range of values of the data-exchange parameter; and
storing the value of the data-exchange parameter that yields the best quality of service for the second values of the collision- and channel-failure probabilities.

64. The method of claim 62, further comprising:
wherein estimating the received-data quality of service comprises estimating the received-data quality of service for the first value of the collision-failure probability, the first value of the channel-failure probability, the value of the first data-exchange parameter, and a value of a second data-exchange parameter;
changing the value of the second data-exchange parameter after changing the value of the first data-exchange parameter over the range of values;
estimating the quality of service for the first value of the collision-failure probability, the first value of the channel-failure probability, a value of the first data-exchange parameter, and the changed value of the second data-exchange parameter;
continuing to change the value of the second data-exchange parameter and to estimate the quality of service over a range of values of the second data-exchange parameter; and
storing the values of the first and second data-exchange parameters that together yield the best quality of service for the first values of the collision- and channel-failure probabilities.

65. A computer-readable medium storing program instructions that when executed by a processor, cause the processor:
to determine a collision-failure probability that an exchange of first data over a wireless channel involving a first unit during a first period will fail due to an exchange of second data over the channel involving a second unit during the first period;
to determine a channel-failure probability that the exchange of the first data over the channel will fail due to a characteristic of the channel; and
to select in response to the collision- and channel-failure probabilities a data-exchange parameter that provides at a receiver of the first data a quality of service that exceeds a level.

66. A computer-readable medium storing program instructions that when executed by a processor, cause the processor:
to estimate a received-data quality of service for a first value of a collision-failure probability, a first value of a channel-failure probability, and a value of a data-exchange parameter;
to change the value of the data-exchange parameter;
to estimate the quality of service for the first value of the collision-failure probability, the first value of the channel-failure probability, and the changed value of the data-exchange parameter;
to continue to change the value of the data-exchange parameter and to estimate the quality of service over a range of values of the data-exchange parameter; and
to store the value of the data-exchange parameter that yields the best quality of service for the first values of the collision- and channel-failure probabilities.
